(19) United States
(12) Patent Application Publication
(10) Pub. No.: US 2004/0139399 A1
(43) Pub. Date: Jul. 15, 2004

(54) Image forming apparatus and image forming method

(75) Inventor: Naomi Nakane, Kanagawa-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/341,460

(22) Filed: Jan. 14, 2003

(51) Int. Cl. G06K 1/00

(52) U.S. Cl. 715/526

(57) ABSTRACT

A main control section in an image processing apparatus inserts a PC created document in a scanned image to output it using a printer section or to transmit it to a personal computer (PC) using a network on the basis of page information to which tag information is given.

### BACKGROUND OF THE INVENTION

The present invention relates to an image forming apparatus to which a personal computer capable of making bidirectional communication via a network is connected and which forms an image by reading an image of an original by a scanner, and an image forming method therefor.

In recent years, digital multi functional peripheral on which a copying machine and a printer, and further a network scan function are mounted have been widely used increasingly. Further, in this digital multi functional peripheral, a finisher or the like is mounted so that finishing (staple, magazine sort, saddle stitch, or the like) is set with respect to an output image, thereby creating a simple booklet.

Conventionally, in an image forming apparatus such as a digital multi functional peripheral, when a document created by a personal computer (PC) is desired to be inserted in an image original, a print function is used to transmit document data from the PC at first, and an document original printed out is manually inserted between pieces of the image original after printout. Further, since all post-processings such as stapling and the like are manually performed, remarkable inefficiency was a problem.

Though outputting can be performed using a copying function after inserting the document printed out in the image original, since the image printed out is copied, the image quality is deteriorated so that the image is made unclear.

When the image data made into a file using the scan function and the data where the PC created document is mixed are desired to transmitted together via e-mail or the like, data made into files separately form each other are transmitted or data in which an image scanned on the PC is inserted is transmitted, so that remarkable inefficiency was a problem.

### BRIEF SUMMARY OF THE INVENTION

It is an object of the present invention to provide an image forming apparatus and an image forming method capable of inserting document data created by a personal computer in scanned image data, further applying finishing processing to efficiently output an image using a network.

In order to achieve the above object, the present invention provides an image forming apparatus which is connected to an external device via a communication line and forms an image, comprising a reading section which reads an image of an original, a storing section which stores first image data read in the reading section therein, an image forming section which forms an image on the basis of the image data stored in the storing section, a receiving section which receives second image data transmitted from the external device via the communication line, a first control section which controls to store the second image data received by the receiving section in the storing section, a setting section which sets image forming information for forming an image by inserting the second image data into the first image data stored in the storing section, and a second control section which controls to form an image in the image forming section by reading the first image data and the second image data stored in the storing section and inserting the second image data into the first image data on the basis of the image forming information set by the setting section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a section view showing an internal structure of a digital multi functional peripheral according to an image forming apparatus of the present invention;

FIG. 2 is a block diagram showing a schematic configuration of the digital multi functional peripheral;

FIG. 3 is a flow chart for explaining a processing operation according to a first embodiment of the present invention;

FIG. 4 is a flow chart for explaining the processing operation according to the first embodiment;

FIG. 5 is a flow chart for explaining an processing operation according to a second embodiment of the present invention; and

FIG. 6 is a flow chart for explaining the processing operation according to the second embodiment.

### DETAILED DESCRIPTION OF THE INVENTION

Hereinafter, one embodiment according to the present invention will be described with reference to the drawing.

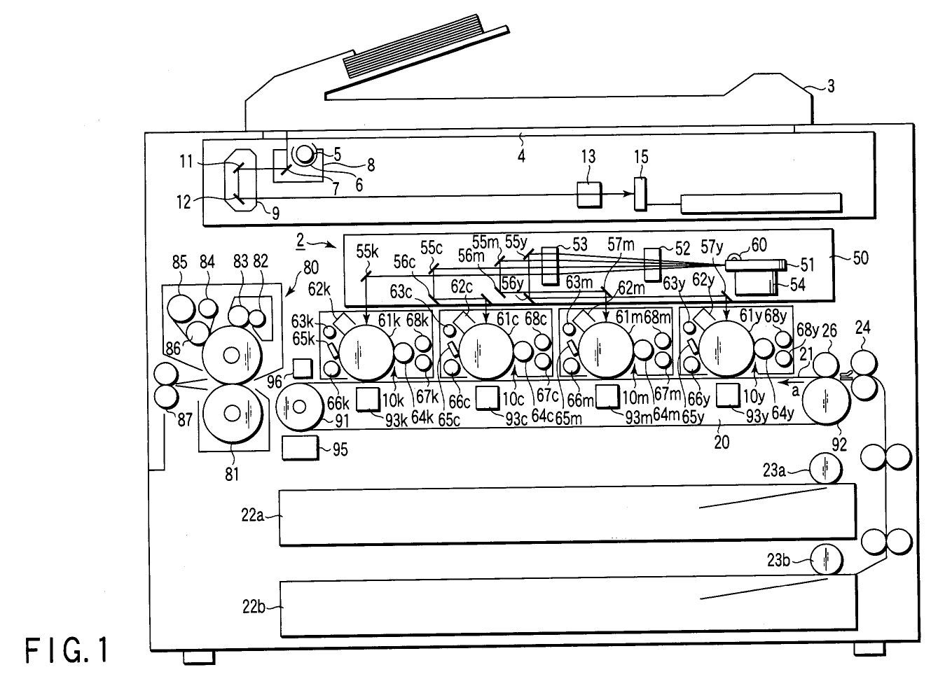

FIG. 1 schematically shows an internal structure of an image forming apparatus such as a digital color copying machine for forming a copied image of a color image according to the present invention. This image forming apparatus is roughly configured with a color scanner section 1 as image reading means for reading a color image on an original and a color printer section 2 as image forming means for forming a copied image of the read color image.

The color scanner section 1 has an automatic document feeder (ADF) 3 thereon, and a platen 4 which is arranged opposite to the ADF 3 in a closed state and is made of a transparent glass on which an original is set. There are arranged an exposure lamp 5 for illuminating an original placed on the platen 4, a reflector 6 for focusing a light from the exposure lamp 5 on the original, and a first mirror 7 for reflecting a reflected light form the original to the left direction with respect to the drawing below the platen 4. The exposure lamp 5, reflector 6, and first mirror 7 are fixed to a first carriage 8. The first carriage 8 is driven by a pulse motor (not shown) to be moved in parallel along the lower face of the platen 4.

A second carriage 9 movably provided in parallel to the platen 4 via a driving mechanism (not shown) (for example, toothed belt and DC motor) is arranged at the left side in the drawing with respect to the first carriage 8, that is, in the direction in which a light reflected by the first mirror 7 is guided. In the second carriage 9, a second mirror 11 for reflecting a reflected light from the original guided by the first mirror 7 downward in the drawing and a third mirror 12 for reflecting a reflected light from the second mirror 11 to the right direction in the drawing are arranged in an orthogonal manner to each other. The second carriage 9 is followed by the first carriage 8, and is moved in parallel along the platen 4 at half speed relative to the first carriage 8.

An imaging lens 13 for imaging a reflected light from the third mirror 12 at a predetermined magnification is arranged in the plane including a optical axis of the light reflected at the second and third mirrors 11 and 12. Also, a CCD type color image sensor (photoelectric conversion element) 15 for converting a reflected light to which a focusing characteristic is given by the imaging lens 13 into an electric signal is arranged in the plane which is substantially orthogonal to the optical axis of the light passing through the imaging lens 13.

However, when the light from the exposure lamp 5 is focused on the original on the platen 4 by the reflector 6, the reflected light from the original is incident in a color image sensor 15 via the first mirror 7, second mirror 11, third mirror 12, and imaging lens 13, where the incident light is converted into electric signals according to three primary colors of a light of R (red), G (green), and B (blue).

The color printer section 2 has first to fourth image forming sections 10y, 10m, 10c, and 10k for forming images color-decomposed for each color component, that is images of four colors of yellow (y), magenta (m), cyan (c), and black (b), respectively, on the basis of a well-known subtractive color mixture method.

A carrying mechanism 20, which includes a carrying belt 21 as carrying means for carrying an image for each color formed by each image forming section in the arrow “a” direction in the drawing, is arranged below the image forming sections 10y, 10m, 10c, and 10k. The carrying belt 21 is wounded around and stretched between a driving roller 19 rotating in the arrow “a” direction by a motor (not shown) and a driven roller 92 separated from the driving roller 91 at a predetermined distance, and is endlessly run at a constant speed in the arrow “a” direction. The image forming sections 10y, 10m, 10c, 10k are arranged in series along the carrying direction of the carrying belt 21.

The image forming sections 10y, 10m, 10c, and 10k include photosensitive drums 61y, 61m, 61c, and 61k as an image carrier whose outer face is formed to be rotatable in the same direction at the position contact with the carrying belt 21, respectively. Each photosensitive drum 61y, 61m, 61c, 61k is configured to be rotated at a predetermined speed by a motor (not shown).

The respective photosensitive drums 61y, 61m, 61c, and 61k are arranged such that axis lines thereof are arranged at equal intervals from each other and the axis lines thereof are orthogonal to the direction in which the image is carried by the carrying belt 21. In the following description, the axis line direction of each photosensitive drum 61y, 61m, 61c, 61k is assumed as a main scanning direction (second direction), and the rotating direction of the photosensitive drums 61y, 61m, 61c, and 61k, that is, the rotating direction (arrow “a” direction in the drawing) of the carrying belt 21 is assumed as a sub-scanning direction (first direction).

There are arranged electrostatic charging devices 62y, 62m, 62c, 62k as electrostatic charging means extended in the main scanning direction, destaticizing devices 63y, 63m, 63c, 63k, developing rollers 64y, 64m, 64c, 64k as developing means similarly extended in the main scanning direction, lower mixing rollers 67y, 67m, 67c, 67k, upper mixing rollers 68y, 68m, 68c, 68k, transferring devices 93y, 93m, 93c, 93k as transferring means similarly extended in the main scanning direction, cleaning blades 65y, 65m, 65c, 65k similarly extended in the main scanning direction, and discharged toner recovery screws 66y, 66m, 66c, 66k around the photosensitive drums 61y, 61m, 61c, 61k, respectively, in the order along the rotating direction of the photosensitive drums 61y, 61m, 61c, 61k.

Each transferring device 93y, 93m, 93c, 93k is arranged at the position where the carrying belt 21 is sandwiched with the corresponding photosensitive drums 61y, 61m, 61c, 61k, that is, inside the carrying belt 21. Further, exposure points by the exposure device 50 are formed on the outer faces of the photosensitive drums 61y, 61m, 61c, 61k between the electrostatic charging devices 62y, 62m, 62c, 62k and the developing rollers 64y, 64m, 64c, 64k, respectively.

There are arranged sheet cassettes 22a and 22b in which a plurality of sheets P as a medium to which an image is formed, to which an image formed by each image forming section 10y, 10m, 10c, 10k is transferred are accommodated, below the carrying mechanism 20.

There are arranged pickup rollers 23a and 23b for picking up a sheet P accommodated in the sheet cassettes 22a and 22b from the uppermost by one sheet at one ends of the sheet cassettes 22a and 22b, that is, at the side in proximity to the driven roller 92. There is arranged a resist roller 24 for matching an edge of the sheet P picked up from the sheet cassette 22a, 22b and an edge of a y toner image formed by the photosensitive drum 61y of the image forming section 10y between the pickup rollers 23a, 23b and the driven roller 92. The toner images formed in the other photosensitive drums 61y, 61m, 61c are supplied to the respective transfer positions in timing with carrying of the sheet P carried on the carrying belt 21.

There is arranged an adsorbing roller 26 for giving electrostatic adsorbing force to the sheet P carried at a predetermined timing via the resist roller 24 between the resist roller 24 and the first image forming section 10y and in the vicinity of the driven roller 92, that is, on the outer face of the driven roller 92 substantially sandwiching the carrying belt 21. The axis line of the adsorbing roller 26 and the axis line of the driven roller 92 are set to be parallel to each other.

There is arranged a positional deviation sensor 96 for detecting a position of the image formed on the carrying belt 21 at one end of the carrying belt 21 and in the vicinity of the driving roller 91, that is, on the outer face of the driving roller 91 substantially sandwiching the carrying belt 21.

The positional deviation sensor 96 is configured with, for example, a transmission type or reflection type optical sensor.

There is arranged a carrying belt cleaning device 95 for removing toners attached on the carrying belt 21 or sheet dusts of the sheet P on the outer face of the driving roller 91 and on the carrying belt 21 at the downstream side of the positional deviation sensor 96.

There is arranged a fixing device 80 for melting the toner image transferred on the sheet P by heating the sheet P up to the predetermined temperature and fixing the toner image on the sheet P in the direction in which the sheet P carried via the carrying belt 21 is separated from the driving roller 91 and is further carried.

The fixing device 80 is configured with a heat roller pair 81, oil applying rollers 82, 83, a web winding roller 84, a web roller 85, and a web pressing roller 86. The toner formed for the sheet P is fixed on the sheet and discharged by a sheet discharging roller pair 87.

The exposure device 50 which forms an electrostatic latent image color-separated on the outer face of each photosensitive drum 61y, 61m, 61c, 61k has a semiconductor laser oscillator 60 emission-controlled on the basis of image data (Y, M, C, K) for each color color-separated in an image processing device 36 described later.

There are provided a polygon mirror 51 rotated by a polygon motor 54 for reflecting and scanning a laser beam light and fθ lenses 52 and 53 for correcting the focal point of the laser beam light reflected via the polygon mirror 51 to form an image on the optical path of the semiconductor laser oscillator 60 in this order.

First reflecting mirrors 55y, 55m, 55c, 55k, and second and third reflecting mirrors 56y, 56m, 56c, 57y, 57m, 57c are arranged between the fθ lens 53 and each photosensitive drum 61y, 61m, 61c, 61k. The first reflecting mirrors 55y, 55m, 55c, 55k reflect the laser beam light for each color passing through the fθ lens 53 toward the exposure position of each photosensitive drum 61y, 61m, 61c, 61k. The third reflecting mirrors 56y, 56m, 56c, 57y, 57m, 57c further reflect the laser beam light reflected by the first reflecting mirrors 55y, 55m, 55c. In addition, the laser beam light for black is reflected by the first reflecting mirror 55k, and is then guided on the photosensitive drum 61k not through the other mirrors.

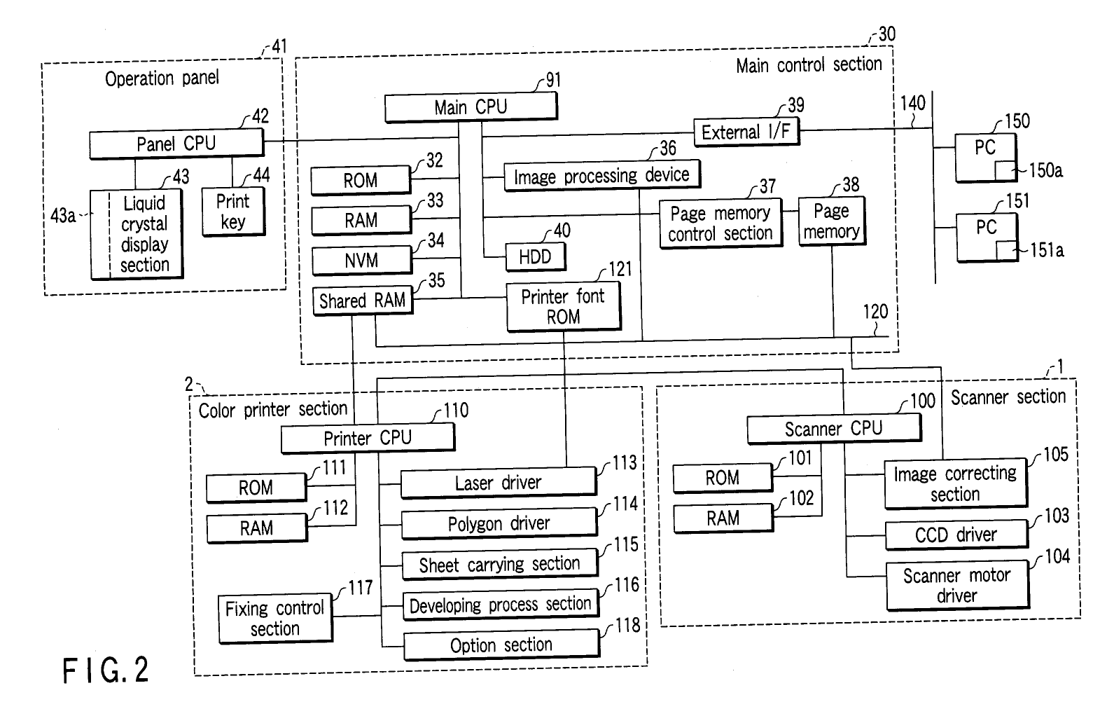

FIG. 2 is a block diagram showing a schematic configuration of the flow of signals for the electric connections and control of the digital multi functional peripheral shown in FIG. 1. In FIG. 2, a control system is configured with three CPUs, i.e., a main CPU (central processing unit) 91 in a main control section 30, a scanner CPU 100 of the color scanner section 1, and a printer CPU 110 of the color printer section 2. The main CPU 91 is directed for making bidirectional communication via the printer CPU 110 and a shared RAM (random access memory) 35, where the main CPU 91 issues an operation instruction and the printer CPU 110 returns the status. The printer CPU 110 and the scanner CPU 100 make serial communication, where the printer CPU 100 issues an operation instruction and the scanner CPU 100 returns the status. An operation panel 41 has a touch panel 43a, a liquid crystal display section 43, various operation keys (for example, print keys) 44, and a panel CPU 42 connected thereto, and is connected to the main CPU 91. The main control section 30 is configured with the main CPU 91, a ROM (read only memory) 32, a RAM 33, a NVRAM 34, the shared RAM 35, the image processing device 36, a page memory control section 37, a page memory 38, an external interface (external I/F) 39, a hard disk device (HDD) 40, and a printer font ROM 121. The main CPU 91 is directed for governing the entire control. The ROM 32 stores control programs and the like therein. The RAM 33 is directed for temporarily storing data therein.

The NVRAM (nonvolatile random access memory) 34 is a nonvolatile memory backed up in a battery (not shown) and holds stored data even when the power supply is shut off. The shared RAM 35 is used for making bidirectional communication between the main CPU 91 and the printer CPU 110. The page memory control section 37 is directed for storing or reading image information with respect to the page memory 38. The page memory 38 has an area in which the image information for a plurality of pages can be stored, and is formed so as to store compressed data of the image information from the color scanner section 1 for one page. The printer font ROM 121 stores font data corresponding to the print data therein. The external I/F 39 is connected to PCs 150 and 151 via a network 140. The PCs 150 and 151 have display sections 150a and 151a, respectively.

The digital multi functional peripheral 1 utilizes the PCs 150, 151 and the network 140 (Internet, LAN, or the like) to exchange information. This is a network scan function. Thereby a user can utilize information scanned via the network 140 or information in an external device such as the PU 150 or 151. For example, a document or the like created by the PC using the print function is printed out, or an original is scanned using the scanner function and made into an electronic file to be transmitted via e-mail.

The color scanner section 1 is configured with the scanner CPU 100 which governs the entire control, a ROM 101 having control programs and the like stored therein, a data storage RAM 102, a CCD driver 103 for driving the color image sensor 15, a scanning motor driver 104 for controlling rotation of the scanning motor that moves the first carriage 8 or the like, and an image correcting section 105. The image correcting section 105 is configured with an A/D converting circuit for converting analog signals of R, G, B output from the color image sensor 15 into digital signals, respectively, a shading correcting circuit for correcting fluctuation of a threshold level with respect to the output signal from the color image sensor 15 due to a variation of the color image sensor 15 or change in ambient temperature, a line memory for temporarily storing the shading-corrected digital signal from the shading correcting circuit therein, and the like.

The color printer section 2 is configured with the printer CPU 110 which governs the entire control, a ROM 111 having control programs and the like stored therein, a data storage RAM 112, a laser driver 113 for driving the semiconductor laser oscillator 60, a polygon motor driver 114 for driving the polygon motor 54 of the exposure device 50, a carrying control section 115 for controlling carriage of the sheet P by the carrying mechanism 20, a process control section 116 for controlling processes of performing charging, developing, and transferring using the electrostatic charging device, the developing roller, and the transferring device, a fixing control section 117 for controlling the fixing device 80, an option control section 118 for controlling an option, and the like. The image processing section 36, page memory 38, printer controller 39, image correcting section 105, laser driver 113, shared RAM are connected via an image data bus 120.

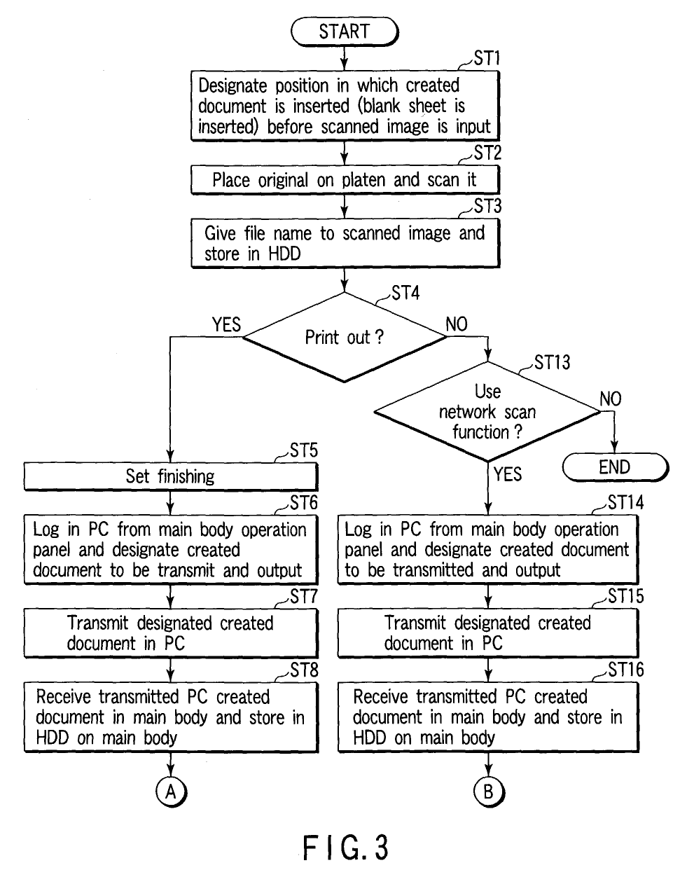

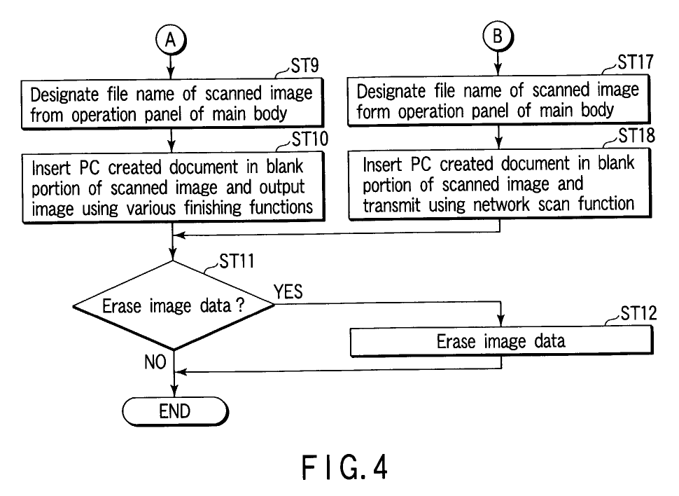

Next, the processing operation according to the first embodiment will be described with reference to the flow charts in FIGS. 3 and 4.

At first, before a scanned image of an original is input, a position (page) where a document created by the PC 150 is inserted in this scanned image is designated (ST1). According to the first embodiment, this designating is performed by inserting a blank sheet into the inserting position (page). For example, it is assumed that five pages in total including four pages of the scanned image of the original and one page of the created document are output. At this time, the user inserts the blank sheet into the page (for example, third page) to which he/she wants to insert the PC created document. In other words, scanning is performed assuming that the first page is the original, the second page is the original, the third page is the blank sheet, the fourth page is the original, and the fifth page is the original.

Here, the original to be scanned including the blank sheet is placed on the ADF 3. When the user instructs scanning through the operation panel 41, the main CPU 91 uses the ADF 3 and the color scanner section 1 to scan the original (ST2). The main CPU 91 temporarily stores the scanned image in the HDD 40.

The user uses the operation panel 41 to set a file name (file header) of the scanned image. For example, it is assumed that “file A” is set as the file name. The main CPU 91 gives the file name “file A” to this scanned image and stores it in the HDD 40 (ST3). The user may perform compression processing on the scanned image and store it in the HDD 40 as required.

Subsequently, the main CPU 91 displays whether or not to print out the “file A” on the liquid crystal display section 43 to confirm for the user (ST4).

When an instruction of printing out the “file A” is issued, the user further uses the operation panel 41 to set finishing (ST5). Subsequently, the user logs in the PC 150 from the operation panel 41 via the network 140 and designates the created document (for example, document B) in the PC 150 (ST6). The PC 150 transmits the “document B” designated via the network 140 to the digital multi functional peripheral (main body) 1 (ST7). When the digital multi functional peripheral 1 receives the “document B”, the main CPU 91 stores the “document B” in the HDD 40 (ST8).

Here, the user designates the “file A” stored in the HDD 40 form the operation panel 41 (ST9). The main CPU 91 reads the designated “file A” and the “document B” from the HDD 40 and transmits them to the page memory control section 37. At this time, the main CPU 91 confirms the amount of data for one page of the “file A”. In this confirming, the amount of data is compared with a predetermined threshold value to determine whether or not the information includes the amount of data of “blank sheet.” When it is determined that the “blank sheet” is included, the main CPU 91 gives tag information to the page information. As described above, since the blank sheet is read into the third page, the tag information is given to the third page.

The main CPU 91 transmits the page information to the page memory control section 37. The page memory control section 37 controls inserting of the “document B” into the third page to which the tag information of the “file A” is given on the basis of the page information.

At first, the page memory control section 37 develops the first page of the “file A” into bitmap data in the page memory 38 on the basis of the page information and transmits it to the shared RAM 35. Subsequently, the page memory control section 37 develops the second page of the “file A” into bitmap data in the page memory 38 on the basis of the page information and transmits it to the shared RAM 35. At the third page, the page memory control section 37 confirms the tag information on the basis of the page information to develop the “document B” as the third page into bitmap data in the page memory 38 and to transmit it to the shared RAM 35. Further, the page memory control section 37 develops the fourth page of the “file A” into bitmap data in the page memory 38 on the basis of the page information and transmits it to the shared RAM 35. Subsequently, the page memory control section 37 develops the fifth page of the “file A” into bitmap data in the page memory 38 on the basis of the page information and transmits it to the shared RAM 35.

The shared RAM 35 sequentially stores the received information.

The printer CPU 110 reads the image data stored in the shared RAM 35 and outputs it as an image on the basis of the finishing previously set in step ST5 (ST10).

As a result, the digital multi functional peripheral 1 inserts the scanned image of the “file A” into the first, second, fourth, and fifth pages and the PC created document of the “document B” into the third page to output as the image.

Subsequently, the main CPU 91 displays whether or not to erase the scanned image (file A) and the PC created document (document B) on the liquid crystal display section 43 to confirm for the user (ST11).

When an instruction of erasing the “file A” and the “document B” is issued, the main CPU 91 erases the image data of the “file A” and the “document B” from the HDD 40 (ST12).

When an instruction of not erasing the image data is issued, the main CPU 91 terminates the processing operation.

Further, there will be described the operation when a selection of not printing out the “file A” of the scanned image is made in step ST4.

That is, when an instruction of not printing out is issued, the main CPU 91 displays whether or not to use the network scan function on the liquid crystal display section 43 to confirm for the user (ST13).

When an instruction of not using the network scan function is issued, the main CPU 91 terminates the processing operation.

When an instruction of using the network scan function is issued, the user further logs in the PC 150 from the operation panel 41 via the network 140 and designates the created document (for example, document B) in the PC 150 (ST14). The PC 150 transmits the designated “document B” via the network 140 to the digital multi functional peripheral (main body) 1 (ST15). When the digital multi functional peripheral (main body) 1 receives the “document B”, the main CPU 91 stores the “document B” in the HDD 40 (ST16).

Here, the user designates the “file A” stored in the HDD 40 through the operation panel 41 (ST17). The main CPU 91 reads the designated “file A” and the “document B” and transmits them via the external I/F 39 and the network 140 to the PC 150.

At this time, the main CPU 91 confirms the amount of data for one page of the “file A.” In this confirming, the amount of data is compared with a predetermined threshold value to determine whether or not the information includes the amount of data of “blank sheet.” When it is determined that the “blank sheet” is included, the main CPU 91 gives tag information to the page information.

As described above, since the blank sheet is read into the third page, the tag information is given to the third page. Thereby, the main CPU 91 controls inserting of the “document B” into the third page to which the tag information of the “file A” is given on the basis of this page information (ST18). As a result, the digital multi functional peripheral 1 inserts the scanned image of the “file A” into the first, second, fourth, and fifth pages, and the PC created document of the “document B” into the third page, and transmits them to the PC 150.

Subsequently, the main CPU 91 displays whether or not to erase the scanned image (file A) and the PC created document (document B) on the liquid crystal display section 43 to confirm for the user (ST11). When an instruction of erasing the “file A” and the “document B” is issued, the main CPU 91 erases the image data of the “file A” and the “document B” from the HDD 40 (ST12).

When an instruction of not erasing the image data of the “file A” and the “document B” is issued, the main CPU 91 terminates the processing operation.

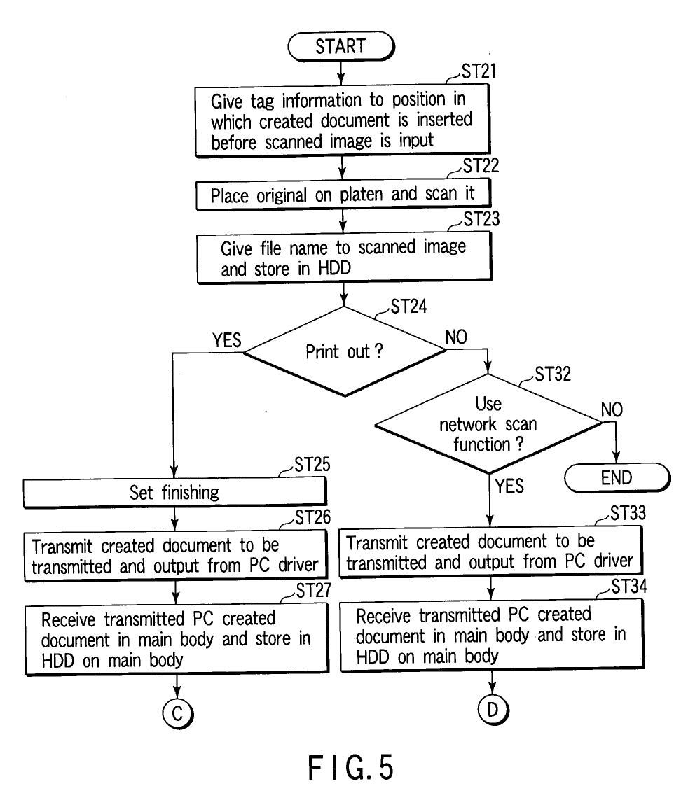

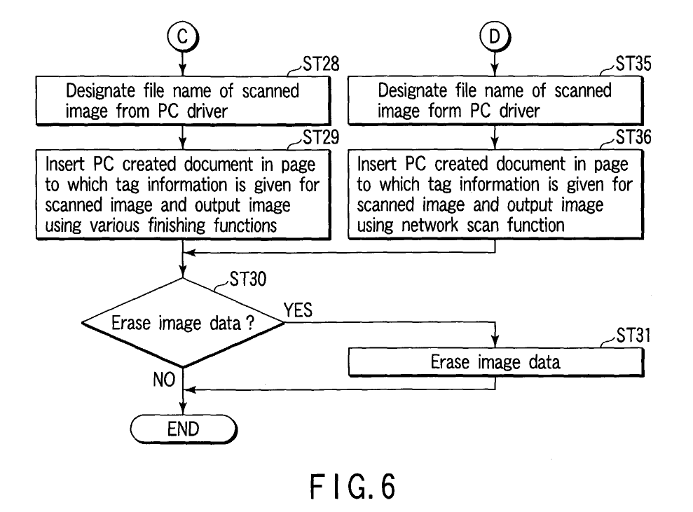

Next, a processing operation according to a second embodiment will be described with reference to the flow charts in FIGS. 5 and 6.

At first, before a scanned image of an original is input, a position (page) where a document created by the PC 150 is inserted into this scanned image is designated (ST21). According to the second embodiment, when the page information is input, the user gives tag information to the inserting position through the operation panel 41. For example, it is assumed that five pages in total including four pages of the scanned image of the original and one page of the PC created document are output. At this time, the user gives the tag information to the page (for example, third page) to which he/she wants to insert the PC created document, and inputs the page information.

Here, the original to be scanned is placed on the ADF 3. When the user instructs to scan through the operation panel 41, the main CPU 91 uses the ADF 3 and the color scanner section 1 to scan the original (ST22). The main CPU 91 temporarily stores the scanned image in the HDD 40.

The user uses the operation panel 41 to set the file name (file header) of the scanned image. For example, it is assumed “file A” is set as the file name. The main CPU 91 gives the file name “file A” to this scanned image and stores it in the HDD 40 (ST23). The user may perform compression processing on the scanned image and store it in the HDD 40 as required.

Subsequently, the main CPU 91 displays whether or not to print out the “file A” on the liquid crystal display section 43 to confirm for the user (ST24).

When an instruction of printing out the “file A” is issued, the user further uses the operation panel 41 to set finishing (ST25).

Here, the user transmits the created document (for example, document B) in the PC 150 via the network 140 to the digital multi functional peripheral (main body) 1 from the driver in the PC 150 (ST26). When the digital multi functional peripheral 1 receives the “document B”, the main CPU 91 stores the “document B” in the HDD 40 (ST27).

The user designates the “file A” stored in the HDD 40 via the network 140 from the driver in the PC 150 (ST28). The main CPU 91 reads the designated “file A” and the “document B” from the HDD 40 and transmits the same to the page memory control section 37.

The main CPU 91 transmits the page information including the tag information to the page memory control section 37. The page memory control section 37 controls to insert the “document B” in the third page to which the tag information is given with respect to the scanned image of “file A” on the basis of the page information including the tag information.

At first, the page memory control section 37 develops the first page of the “file A” into bitmap data in the page memory 38 on the basis of the page information and transmits it to the shared RAM 35. Subsequently, the page memory control section 37 develops the second page of the “file A” into bitmap data in the page memory 38 on the basis of the page information and transmits it to the shared RAM 35. At the third page, the page memory control section 37 confirms the tag information on the basis of the page information to develop the “document B” as the third page into bitmap data in the page memory 38 and to transmit it to the shared RAM 35. Further, the page memory control section 37 develops the third page of the “file A” into bitmap data in the page memory 38 on the basis of the page information and transmits it to the shared RAM 35 as the fourth page. Subsequently, the page memory control section 37 develops the fourth page of the “file A” into bitmap data in the page memory 38 on the basis of the page information and transmits it to the shred RAM 35 as the fifth page.

The shred RAM 35 sequentially stores the received information.

The printer CPU 110 reads the image data stored in the shred RAM 35 and outputs as an image on the basis of the finishing previously set in step ST5 (ST29).

As a result, the digital multi functional peripheral 1 inserts the scanned image of the “file A” into the first, second, fourth, and fifth pages and the PC created document of the “document B” into the third page and outputs the same as the image.

Thereafter, the main CPU 91 displays whether or not to erase the scanned image (file A) and the PC created document (document B) on the display section 150a in the PC 150 to confirm for the user (ST30).

When an instruction of erasing the “file A” and the “document B” is issued, the main CPU 91 erases the image data of the “file A” and the “document B” from the HDD 40 (ST31).

When an instruction of not erasing the image data is issued, the main CPU 91 terminates the processing operation.

Further, there will be described an operation when a selection of not printing out the “file A” of the scanned image is made in step ST4.

That is, when an instruction of not printing out is issued, the main CPU 91 displays whether or not to use the network scan function on the display section 150a in the PC 150 to confirm for the user (ST32).

When an instruction of not using the network scan function is issued, the main CPU 91 terminates the processing operation.

When an instruction of using the network scan function is issued, the user transmits the created document (for example, document B) in the PC 150 via the network 140 from the driver in the PC 150 to the digital multi functional peripheral (main body) 1 (ST33). When the digital multi functional peripheral (main body) 1 receives the “document B”, the main CPU 91 stores the “document B” in the HDD 40 (ST34).

Here, the user designates the “file A” stored in the HDD 40 via the network 140 from the driver in the PC 150 (ST35). The main CPU 91 reads the designated “file A” and the “document B”, inserts the “document B” in the third page to which the tag information is given with respect to the “file A”, and transmits it to the PC 150 via the external I/F 39 and the network 140 (ST36). As a result, the digital multi functional peripheral 1 inserts the scanned image of the “file A” into the first, second, fourth, and fifth pages and the PC created document of the “document B” into the third page, and transmits the same to the PC 150.

Subsequently, the main CPU 91 displays whether or not to erase the scanned image (file A) and the PC created document (document B) on the display section 150a in the PC 150 to confirm for the user (ST30). When an instruction of erasing the “file A” and the “document B” is issued, the main CPU 91 erases the image data of the “file A” and the “document B” from the HDD 40 (ST31).

When an instruction of not erasing the image data of the “file A” and the “document B” is issued, the main CPU 91 terminates the processing operation.

As described above, according to the embodiments of the present invention, the document data in the PC can be inserted into the scanned image data to be output as the image and the finishing is previously set so that the finishing processing can be performed for this output image. Thereby, a clear image can be output.

Further, the document data in the PC is inserted into the scanned image data thereby enabling to transmit it to an external PC via the network so that the operability of the user can be improved.

The user logs in from the digital multi functional peripheral 1 to the PC 150 according to the first embodiment, and he/she logs in from the PC 150 to the digital multi functional peripheral 1 according to the second embodiment, but the user may log in from either side.

Additional advantages and modifications will readily occur to those skilled in the art. Therefore, the invention in its broader aspects is not limited too the specific details and representative embodiments shown and described herein. Accordingly, various modifications may be made without departing from the spirit or scope of the general inventive concept as defined by the appended claims and their equivalents.

What is claimed is:

1. An image forming apparatus which is connected to an external device via a communication line and forms an image, comprising:
a reading section which reads an image of an original;
a storing section which stores first image data read in the reading section therein;
an image forming section which forms an image on the basis of the image data stored in the storing section;
a receiving section which receives second image data transmitted from the external device via the communication line;
a first control section which controls to store the second image data received by the receiving section in the storing section;
a setting section which sets image forming information for forming an image by inserting the second image data into the first image data stored in the storing section; and
a second control section which controls to form an image in the image forming section by reading the first image data and the second image data stored in the storing section and inserting the second image data into the first image data on the basis of the image forming information set by the setting section.

2. An image forming apparatus according to claim 1, wherein, when the order of pages in which an image of the first and second image data is formed is input, tag information is given to the page to which the second image data is inserted with respect to the order of pages of the first image data in the setting section.

3. An image forming apparatus according to claim 1, wherein, when tag information is given to the order of pages in the set image forming information, the second control section controls to form an image by inserting the second image data into the page to which the tag information is given.

4. An image forming apparatus according to claim 1, wherein, when a page of blank sheet is present in the first image data, the second control section controls to form an image by inserting the second image data into the page.

5. An image forming apparatus according to claim 4, wherein the second control section compares the amount of data per page in the first image data and a predetermined threshold value to determine whether or not a blank sheet is included.

6. An image forming apparatus which is connected to an external device via a communication line and forms an image, comprising:
a reading section which reads an image of an original;
a storing section which stores first image data read by the reading section therein;
a receiving section which receives second image data transmitted from the external device via the communication line;
a first control section which controls to store the second image data received by the receiving section into the storing section;
a setting section which sets to transmit inserting information for inserting the second image data in the first image data stored in the storing section and image data based on the inserting information to the external device; and
a second control section which controls to read the first image data and the second image stored in the storing section and to insert the second image data in the first image so as to transmit it via the communication line to the external device.

7. An image forming method for an image forming apparatus which is connected to an external device via a communication line and forms an image, the method comprising:
storing first image data obtained by reading an image of an original in the storing section;
receiving second image data transmitted from the external device via the communication line;
storing the received second image data in the storing section;
setting inserting information for inserting the second image data in the first image data stored in the storing section; and
controlling to read the first image data and the second image data stored in the storing section and to insert the second image data in the first image data on the basis of the set inserting information.
